(19) United States
(12) Patent Application Publication
(10) Pub. No.: US 2013/0339145 A1
(43) Pub. Date: Dec. 19, 2013

(54) TRACKING AND SUMMARIZING PURCHASE INFORMATION

(71) Applicant: Visa International Service Association, San Francisco, CA (US)

(72) Inventors: Marc Blum, San Mateo, CA (US); Madhu Vasu, Foster City, CA (US)

(73) Assignee: Visa International Service Association, San Francisco, CA (US)

(21) Appl. No.: 13/952,291

(22) Filed: Jul. 26, 2013

Related U.S. Application Data
(63) Continuation of application No. 13/887,141, filed on May 3, 2013.
Application No. 13/887,141 is a continuation of application No. 13/367,027, filed on Feb. 6, 2012.
(60) Provisional application No. 61/440,164, filed on Feb. 7, 2011.

(51) Int. Cl. G06Q 30/02; G06Q 30/06

(52) U.S. Cl. CPC G06Q 30/0255; G06Q 30/0601
USPC 705/14.53; 705/26.1

(57) ABSTRACT

Embodiments track and summarize a user's purchasing activity. Tracking a user's purchasing activity, according to some embodiments, involves accessing user emails and payment transaction data, parsing the emails and payment transaction data to obtain relevant purchase data, and/or obtaining relevant purchase data via other channels from the user, merchants, financial institutions, and other entities. Summarizing a user's purchasing activity, according to some embodiments, involves generating a summary report organized around the user's individual purchase transactions. The summary reports, for example, help users track and manage their purchases, such as by enabling users to keep track of which items were purchased from which merchants and for how much, and whether the items have been shipped, delivered, canceled, etc.

### CROSS-REFERENCES TO RELATED APPLICATIONS

This application claims benefit under 35 U.S.C. §119(e) of U.S. patent application Ser. No. 13/887,141, entitled “TRACKING AND SUMMARIZING PURCHASE INFORMATION,” filed May 3, 2013, U.S. patent application Ser. No. 13/367,027, entitled “COLLECTING AND ORGANIZING TRANSACTION DATA ASSOCIATED WITH ONLINE PURCHASES,” filed Feb. 6, 2013, and U.S. provisional patent application No. 61/440,164, entitled “COLLECTING AND ORGANIZING TRANSACTION DATA ASSOCIATED WITH ONLINE PURCHASES,” filed Feb. 7, 2011, the entire disclosure of which is incorporated herein by reference for all purposes.

### BACKGROUND

Consumers may have the need to obtain and review information (e.g., price paid, description, payment method, delivery status, confirmation code, order number, etc.) related to goods and/or services that they have purchased, ordered, or otherwise acquired. Many consumers make multiple purchases from multiple merchants on a daily or weekly basis. In such cases, it may be difficult for consumers to obtain and review information related to these purchases. For example, if a consumer wanted to obtain and review information related to his or her recent purchases, the consumer may have to access multiple merchant websites to obtain information for purchases made at those websites, review paper receipts, review the transaction history of one or more payment accounts used to make purchases, and/or the like. This may be difficult and time consuming.

Consumers may also have the need to obtain and review promotional offers that merchants have offered to them. For example, merchants often electronically mail promotional offers to consumers. However, many consumers do not utilize these promotional offers because the consumers lose track of, overlook, and/or ignore these offers.

Embodiments of the invention address these and other problems, individually and collectively.

### BRIEF SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to some embodiments, systems and methods are provided for tracking and summarizing a user's purchasing activity. Tracking a user's purchasing activity, according to some embodiments, involves accessing user emails and payment transaction data (e.g., credit-card data), parsing the emails and payment transaction data to obtain relevant purchase data, and/or obtaining relevant purchase data via other channels from the user, merchants, financial institutions, and other entities. Summarizing a user's purchasing activity, according to some embodiments, involves generating a report organized around the user's individual purchase transactions. For example, the report includes, for each purchase transaction, a description of the purchased item(s), the purchase date and amount, the payment account used, an indication of whether the purchase was made online, a confirmation number, a shipment status (e.g., order being processed, shipped, delivered, on back order, etc.), a delivery tracking number, a cancellation notice, updates, etc. The summary reports help users track and manage their purchases, such as by enabling users to keep track of which items were purchased from which merchants and for how much, and whether the items have been shipped, delivered, canceled, etc.

According some embodiments, systems and methods are provided that obtain emails (e.g., confirmation emails from merchants) related to a user's purchases, parse the emails to extract relevant purchase data, organize the extracted purchase data, and provide the user with a summary report of the purchase data, thereby making it easy for users to track their purchases. Further, according to some embodiments, after obtaining an email related to a user purchase, systems and methods determine whether information provided in the email is related to an existing purchase transaction (e.g., a purchase for which the system already has received data). If so, the extracted data is appended to the already-existing data for that purchase transaction.

According to other embodiments, systems and methods are provided that obtain a user's payment transaction data (e.g., credit-card transaction data), parse the transaction data to identify and extract relevant purchase data, and provide the user with a summary report of the user's purchasing activities. In some embodiments, the user may specify filter criteria for determining which purchase transactions to include in the summary report. The filter criteria can include, for example, a purchase date range, a purchase amount range, one or more merchant identifiers, a shipping status, and a payment account used, and/or the like. For example, the user can limit the summary report to online purchases made in the last three months. In this case, the systems and methods parse the user's transaction data to identify and extract purchase data associated with online purchases made in the last three months, and then generate the requested summary report using the extracted data. For each purchase transaction, the extract transaction data includes data fields, such as price, quantity, description, payment method, delivery status, confirmation code, order number, and/or the like.

According to some embodiments, systems and methods may obtain supplemental purchase data for particular purchase transactions from relevant merchants, financial institutions, and/or other entities. For example, in the event a user requests a summary report having data fields, such as item description, shipment status, confirmation number, and/or the like, but the user's payment transaction data (e.g., credit-card transaction data) does not include the requested data fields for some or all of the purchase transactions, the systems and methods obtain supplemental purchase data from the relevant merchant, financial institution, and/or other entity. For example, to obtain supplemental purchase data for a particular purchase transaction, the systems and methods send the relevant merchant, financial institution, and/or other entity identifying information about the transaction (e.g., date and user's name), along with a request that the merchant reply with supplemental purchase data for the transaction.

Embodiments of the present invention provide advantages over currently available purchase-activity reports provided by financial institutions (e.g., credit-card statements provided by card-issuing banks that list user purchases) and merchants (e.g., list of historical purchases provided by online merchants). The current systems and methods provide customizable reports that account for purchases made across multiple merchants, using multiple payment accounts, and that include detailed information not available to financial institutions, such as “confirmation number,” “shipment status” (e.g., order being processed, shipped, delivered, on back order, etc.), “delivery tracking number,” “item description”, and/or the like. While financial institutions can provide account statements that list purchases made using a payment account (e.g., credit card), these account statements do not include detailed information, such as “confirmation number”, “shipment status”, “delivery tracking number”, “item description”, and/or the like. Nor do these account statements provided by financial institutions include data for purchases made using other payment accounts administered by other financial institutions. Further, while a merchant can provide a list of historical purchases made from that merchant, where the list may include detailed information about the individual purchases, such as “item description”, “shipping status”, “confirmation number”, and/or the like, the merchant cannot provide information about purchases made at other merchants. In embodiments of the present invention, however, summary reports can be created that provide detailed information, such as “item description”, “shipping status”, “confirmation number”, and/or the like, about purchases made from multiple merchants using multiple payment accounts administered by multiple financial institutions.

Other embodiments of the invention are directed to computer-readable media comprising code for performing the above-described methods as well as systems, apparatuses and devices that perform the methods and/or that use the computer-readable media.

These and other embodiments of the invention are described in further detail below.

### BRIEF DESCRIPTION OF THE DRAWINGS

FIG. 1 is a block diagram illustrating an example environment in which embodiments may be implemented.

FIG. 2 is a block diagram illustrating example aspects of a system and process for obtaining transaction and promotion information, according to some embodiments.

FIG. 3 is a block diagram illustrating example aspects of another system and process for obtaining transaction and promotion information, according to some embodiments.

FIG. 4 is a block diagram illustrating example aspects of a system and process for obtaining transaction and promotion information using an electronic wallet server and affiliated entities, according to some embodiments.

FIG. 5 is a block diagram illustrating embodiments of an electronic wallet.

FIG. 6 is a logic flow diagram illustrating example aspects of payment processing within an electronic wallet, according to some embodiments.

FIGS. 7a-b are block diagrams illustrating example aspects of processes for obtaining, organizing, and presenting information related to a user's purchasing activity, according some embodiments.

FIG. 8 is a block diagram illustrating example aspects of systems and processes for obtaining, organizing, and presenting information related to user purchases, according some embodiments.

FIG. 9 is a block diagram illustrating example aspects of a process for obtaining, organizing, and presenting information related to a user's purchasing activity, according some embodiments.

FIG. 10 is an example screenshot displaying a summary of a user's purchasing activity, according to an embodiment of the invention.

FIG. 11 is an example screenshot displaying a summary of a user's purchasing activity, according to an embodiment of the invention.

FIG. 12 is an example screenshot displaying promotional offers that may be of interest to a user, according to an embodiment of the invention.

FIG. 13 is a diagram illustrating the components and operation of a network that may be used, or adapted for use, in implementing embodiments of the invention.

FIG. 14 is a diagram illustrating elements that may be present in a computer device and/or system configured to implement a method and/or process in accordance with some embodiments of the present invention.

### DETAILED DESCRIPTION

According to some embodiments, systems and methods are provided for tracking and summarizing a user's purchasing activity. Tracking a user's purchasing activity, according to some embodiments, involves accessing user emails and payment transaction data, parsing the emails and payment transaction data to obtain relevant purchase data, and/or obtaining relevant purchase data via other channels from the user, merchants, financial institutions, and other entities. Summarizing a user's purchasing activity, according to some embodiments, involves generating a report organized around the user's individual purchase transactions. For example, the report includes, for each purchase transaction, a description of the purchased item(s), the purchase date and amount, the payment account used, an indication of whether the purchase was made online, a confirmation number, a shipment status (e.g., order being processed, shipped, delivered, on back order, etc.), a delivery tracking number, a cancellation notice, updates, etc. The summary reports help users track and manage their purchases, such as by enabling users to keep track of which items were purchased from which merchants and for how much, and whether the items have been shipped, delivered, canceled, etc.

According some embodiments, systems and methods are provided that obtain emails (e.g., confirmation emails from merchants) related to a user's purchases, parse the emails to extract relevant purchase data, organize the extracted purchase data, and provide the user with a summary report of the purchase data, thereby making it easy for users to track their purchases. Further, according to some embodiments, after obtaining an email related to a user purchase, systems and methods determine whether information provided in the email is related to an existing purchase transaction (e.g., a purchase for which the system already has received data). If so, the extracted data is appended to the already-existing data for that purchase transaction.

According to other embodiments, systems and methods are provided that obtain a user's payment transaction data (e.g., credit-card transaction data), parse the transaction data to identify and extract relevant purchase data, and provide the user with a summary report of the user's purchasing activities. In some embodiments, the user may specify filter criteria for determining which purchase transactions to include in the summary report. For example, the user can limit the summary report to online purchases made in the last three months. In this case, the systems and methods parse the user's transaction data to identify and extract purchase data associated with online purchases made in the last three months, and then generate the requested summary report using the extracted data. For each purchase transaction, the extract transaction data includes data fields, such as price, quantity, description, payment method, delivery status, confirmation code, order number, and/or the like.

According to some embodiments, systems and methods may obtain supplemental purchase data for particular purchase transactions from relevant merchants, financial institutions, and/or other entities. For example, in the event a user requests a summary report having data fields, such as item description, shipment status, confirmation number, and/or the like, but the user's payment transaction data (e.g., credit-card transaction data) does not include the requested data fields for some or all of the purchase transactions, the systems and methods obtain supplemental purchase data from the relevant merchant, financial institution, and/or other entity. For example, to obtain supplemental purchase data for a particular purchase transaction, the systems and methods send the relevant merchant, financial institution, and/or other entity identifying information about the transaction (e.g., date and user's name), along with a request that the merchant reply with supplemental purchase data for the transaction.

Embodiments of the present invention provide advantages over currently available purchase-activity reports provided by financial institutions (e.g., credit-card statements provided by card-issuing banks that list user purchases) and merchants (e.g., list of historical purchases provided by online merchants). The current systems and methods provide customizable reports that account for purchases made across multiple merchants, using multiple payment accounts, and that include detailed information not available to financial institutions, such as “confirmation number,” “shipment status” (e.g., order being processed, shipped, delivered, on back order, etc.), “delivery tracking number,” “item description”, and/or the like. While financial institutions can provide account statements that list purchases made using a payment account (e.g., credit card), these account statements do not include detailed information, such as “confirmation number”, “shipment status”, “delivery tracking number”, “item description”, and/or the like. Nor do these account statements provided by financial institutions include data for purchases made using other payment accounts administered by other financial institutions. Further, while a merchant can provide a list of historical purchases made from that merchant, where the list may include detailed information about the individual purchases, such as “item description”, “shipping status”, “confirmation number”, and/or the like, the merchant cannot provide information about purchases made at other merchants. In embodiments of the present invention, however, summary reports can be created that provide detailed information, such as “item description”, “shipping status”, “confirmation number”, and/or the like, about purchases made from multiple merchants using multiple payment accounts administered by multiple financial institutions.

Prior to discussing the specific embodiments of the invention, a further description of some terms can be provided for a better understanding of embodiments of the invention.

An “acquirer” is typically a business entity (e.g., a commercial bank) that has a business relationship with a particular merchant.

An “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

An “issuer” is typically a business entity (e.g., a bank) which issues a payment device (such as a credit or debit card) to a consumer. Some entities may perform both issuer and acquirer functions.

An “online purchase” can be the purchase of a digital or physical item or service via a network, such as the Internet.

A “payment account” can include any suitable payment account including a credit card account, a checking account, or a prepaid account.

A “payment device” may include a device that a user may use to conduct a payment transaction. Examples of payment devices include debit cards, credit cards, smart cards, mobile devices such as mobile phones, electronic or digital wallets and other suitable devices.

A “payment processing network” may include data processing subsystems, networks, and other means of implementing operations used to support and deliver authorization services, exception file services, and clearing and settlement services for payment transactions. An exemplary Payment Processing Network may include VisaNet. Payment Processing Networks such as VisaNet are able to process credit card transactions, debit card transactions, and other types of commercial transactions. VisaNet, in particular, includes a VIP system (Visa Integrated Payments system) which processes transaction authorization requests and a Base II system which performs transaction clearing and settlement services.

A “payment transaction” can be a communication carried out between a user and a merchant to exchange an asset, such as a physical or digital item or service, for payment.

“Payment transaction data/information” or “purchase transaction data/information” can include any information corresponding to or describing purchases, orders, invoices, payments involving goods, items, services, and/or the like, and may include, but is not limited to, a purchase amount, a merchant identifier, description code (e.g., NAICS: North American Industry Classification System) associated with purchased items, cost of purchased items, and transactions as well as descriptions of purchased items, purchase dates, purchase amounts, indications of payment accounts used, indications of whether purchases were made online, confirmation numbers, order numbers, cancellation numbers, shipment status updates (e.g., order being processed, shipped, delivered, on back order, etc.), delivery tracking numbers, cancellation notices, updates, and/or the like.

“Promotional offers” can be media and non-media marketing communications employed for a pre-determined, limited time, or indefinitely to increase consumer demand, stimulate market demand or improve product availability. Examples include contests, coupons, premiums, prizes, discounts, rebates, and/or the like.

A “server” can be a powerful computer or a cluster of computers. For example, the server computer can be a large mainframe, a minicomputer cluster, or a group of servers functioning as a unit. In one example, the server computer may be a database server coupled to a Web server.

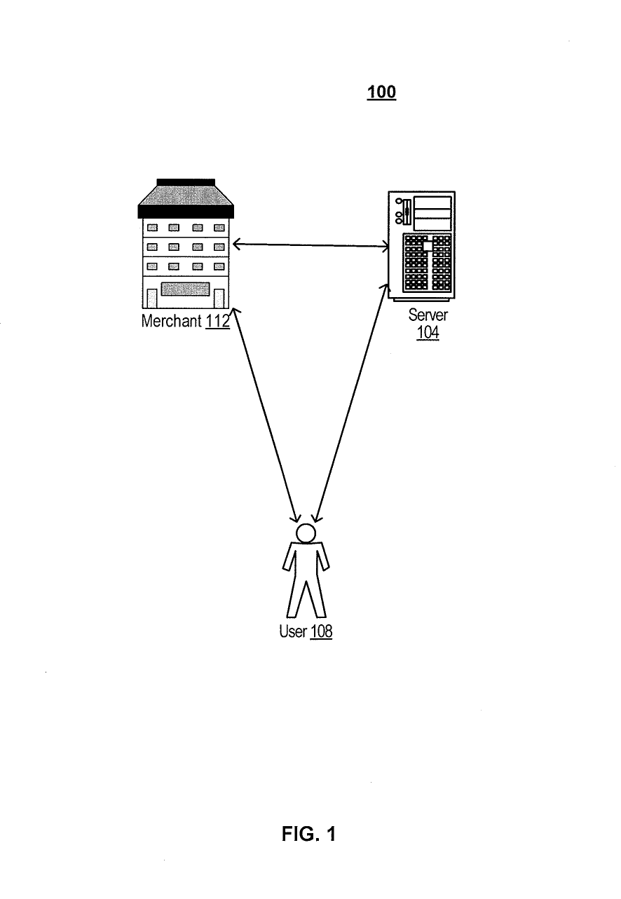

FIG. 1 is an example environment 100 in which embodiments may be implemented. According to FIG. 1, a collecting-and-organizing server 104 (hereinafter referred to as “server 104”) receives purchase transaction data, promotional offers, and other information associated with purchase transactions involving users 108 and merchants 112. It should be appreciated that the server 104 may be associated with, such as being implemented within the frame work of, a financial institution, such as an acquirer and/or an issuer, a payment processing network (e.g., VISA, CYBERSOURCE, etc.), and/or the like. It should also be appreciated that the server 104 may be associated with other institutions, such as Internet companies, software companies, social networking services, email service providers, and/or the like. Further, it should be appreciated that the server 104 can be implemented as a separate entity.

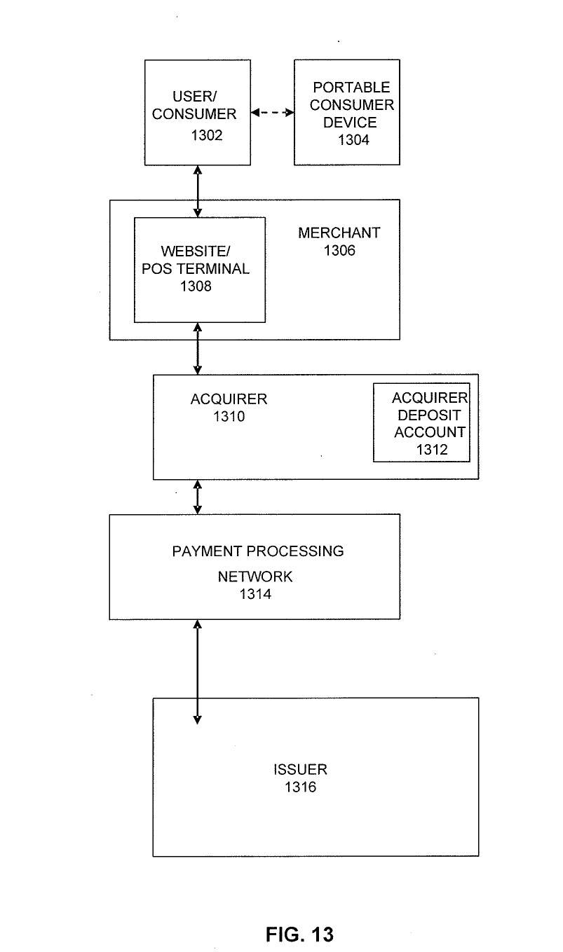

In embodiments where the server 104 is associated with a payment processing network, such as payment processing network 1314 of FIG. 13, the server 104 is capable of accumulating a vast amount of data about users 108, merchants 112, and other entities, because the payment processing network processes transactions involving users 108, merchants 112, and other parties. In addition to being capable of accumulating payment transaction data through its association with entities such as payment processing networks and/or the like, the server 104, according to some embodiments, receives data, directly or indirectly, from merchants 112 and users 108. For example, the server 104 may receive promotional offers from various merchants 112 for the purpose of selectively distributing the offers to users 108. Further, for example, users 108 and merchants 112 may transmit or authorize the transmission of purchase transaction information to the server 104. This purchase transaction information may include data fields such as, for example, “description of the purchased item(s)”, “purchase date”, “purchase amount”, “payment account used”, “an indication of whether the purchase was made online”, “confirmation number, “shipment status” (e.g., order being processed, shipped, delivered, on back order, etc.), “delivery tracking number”, “cancellation notice”, and/or the like. Further, for example, this purchase transaction information may be transmitted from users 108 and merchants 112 to the sever 104 via, for example, SMS, Email, server-to-server transfer over the Internet, and other means of transmitting data. Based on the payment transaction data received from financial institutions, the purchase transaction information received from users 108 and merchants 114, and promotional offer data received from merchants 112, the server 104 may organize and present information related to users' purchases as well as promotional offers that may be relevant to the users 108.

According to some embodiments, the server 104 may be hosted in a cloud-based computing environment (hereinafter the “cloud”). The cloud facilitates, among other things, access to web-based software applications and website services without the requisite need for the local installation, maintenance, and updating of such software or services on the user's computational device (e.g., PC, laptop, smartphone, etc.). For example, a particular server located somewhere on a communication network may host several software applications that may be accessed by one or more users via a web browser (e.g., Internet Explorer™, Firefox™, etc.). Thus, the cloud may facilitate the provision of several data services to consumers utilizing mobile devices such as, for example, smartphones, cell phones, personal digital assistants (PDAs), laptops, tablet PCs (e.g., Apple iPad™), etc. It should be appreciated that all or some of the components of the example systems, such as those illustrated in FIGS. 1-4, 8, and 13, may be hosted in the cloud.

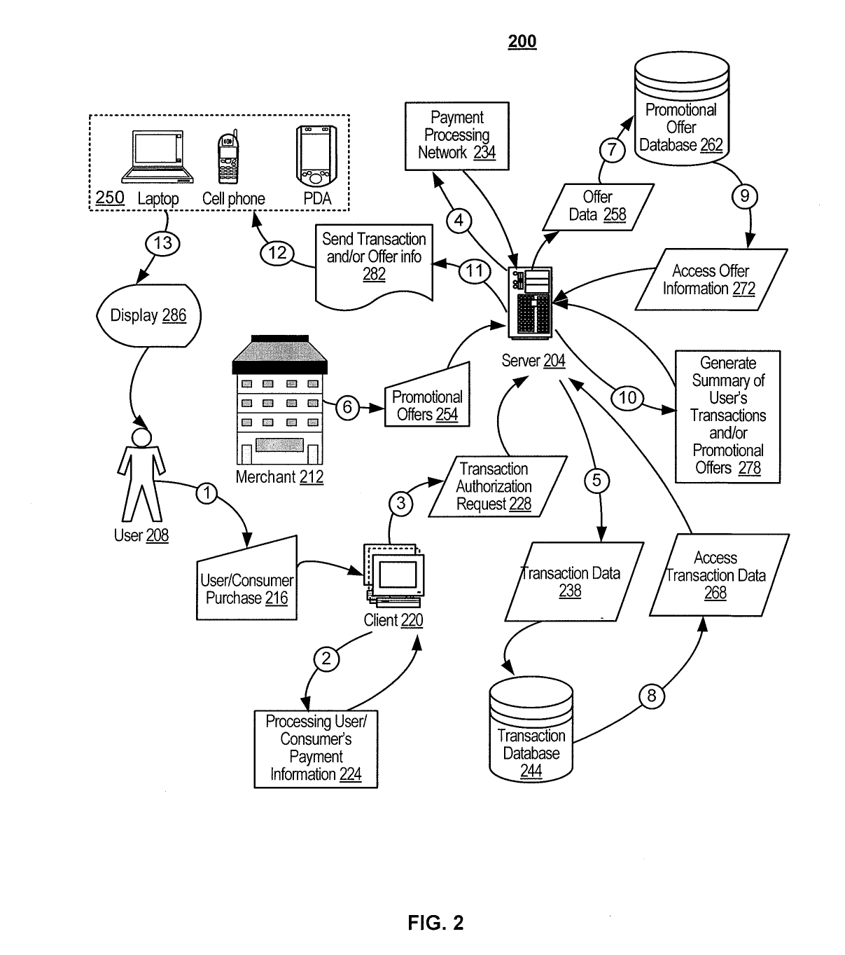

FIG. 2 is of a block diagram illustrating example aspects of systems and processes 200 for obtaining and presenting information related to user purchases and information related to promotions that may be of interest to users, according some embodiments. A user 208 may desire to make a purchase 216 from a merchant 212 by using a client device 220 or a portable consumer device (not shown), such as a credit card, to transmit payment information (e.g., bank account or credit card data) to the merchant 212, such as submitting payment information to the merchant's website or point-of-sale (POS) terminal. In some example aspects, the client device 220 may be a user's 208 web-enable computer (e.g., laptop, desktop, tablet, etc.) or a mobile communication device (e.g., PDA, smartphone, etc.).

According to some embodiments, the merchant 212 transmits the user's payment information 224 along with other purchase transaction information, such as in the form of a transaction authorization request 228, to a processing server 204 (hereinafter referred to as “server 204”), which facilitates a payment processing network 234 with several other financial entities (not shown) such as, for example, an issuer (e.g., user's bank), an acquirer (e.g., merchant's bank), a payment processor network (e.g., VISA, CYBERSOURCE, AUTHORIZE.NET), and/or the like. It should be appreciated that the server 204 may be associated with or implemented as part of the acquirer, the issuer, and/or the payment processor institution. Further, it should be appreciated that, instead of or in addition to transmitting the user's payment information along with other purchase transaction data to the server 204, the merchant 212 can transmit the user's payment information along with other purchase transaction data to the acquirer, the issuer, the payment processor network, and/or the like.

According to some embodiments, the server 204 sends transaction data 238 associated with the user's purchase to a transaction database 244. It should be appreciated that the user 208, the merchant 212, the payment processing network, and/or any other entity may send transaction data 238 to the transaction database 244. The transaction data 238 may include information corresponding to user's purchases, such as a description code (e.g., NAICS: North American Industry Classification System) associated with purchased items, cost of purchased items, and transactions. The transaction data may further include, but not be limited to, a description of the purchased items, the payment accounts used, an indication of whether the purchase was made online, a confirmation number, a shipment status (e.g., order being processed, shipped, delivered, on back order, etc.), a delivery tracking number, a cancellation notice, updates, and/or the like. Still further, the transaction data 238 may include information regarding one or more of the user's communication devices 250 such as, but not limited to, the device name (e.g., Apple iPhone™, Motorola Droid™ etc.), means of communication adopted by each device (e.g., SMS message, Email, etc.), and a user-determinable device preference (e.g., Apple iPhone™ device) for establishing communications.

In some embodiments, the server 204 may send the transaction data 238 to the transaction database 244 based on one or more predefined conditions. For example, in some aspects, the server 204 sends and saves in the transaction database 244 transaction data 238 for purchases that the user tagged as being ones the user would like to track, that were made at an online merchant, that involve physical goods to be shipped to the user 208, and/or the like. According to other aspects, for example, transaction data 238 associated with certain purchase prices (e.g., purchase>$100, purchase<$50, purchase of $1-$75) may be stored in the database 244.

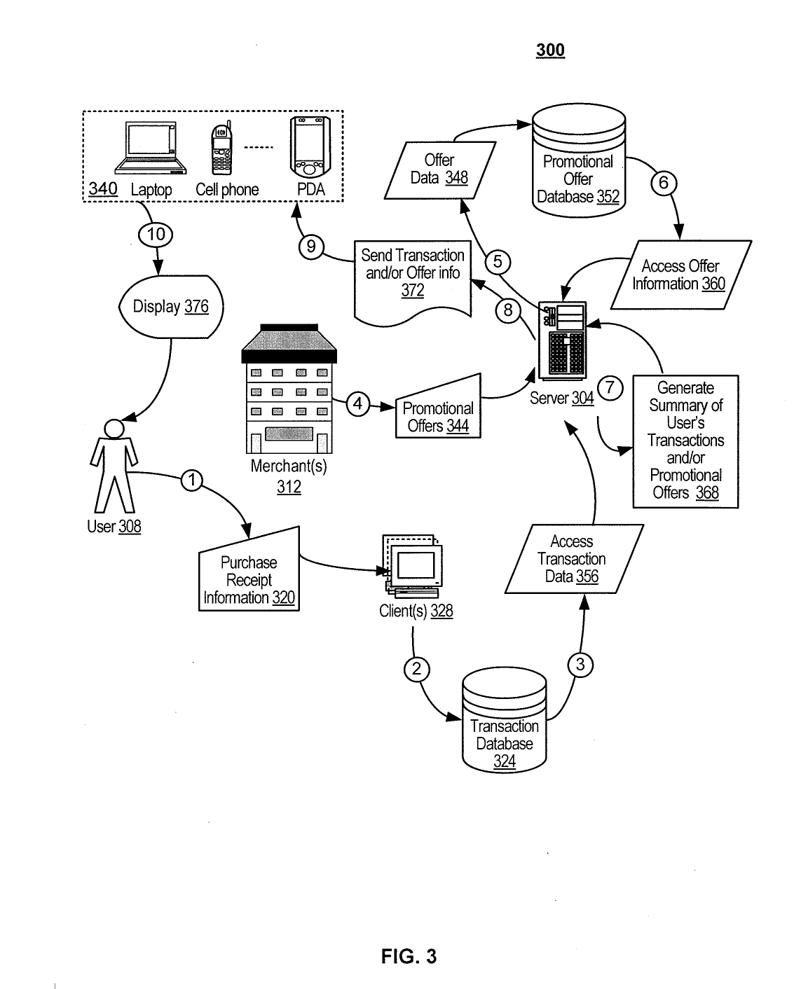

As described in more detail below with reference to FIG. 2 as well as with reference to, for example, FIGS. 3-9, the server 204 will be able to obtain transaction data from the transaction database 244, parse the transaction data to extract relevant information, and present a summary of the relevant information to the user 208.

According to some embodiments, the server 204 may also receive 254 and store 258 promotional offer information that corresponds to various goods or services from different merchants 212 in a promotional offer database 262. For example, one merchant promotional offer may include “Merchant X: 20% reduction from the purchase of any laptop computer within the month of April.” According to another example, “Merchant Y: 6-months of free software and hardware support provided for any laptop computer purchased within the month of May.” For example, transmission of merchant promotional offer information between the merchants 212 and the server 204 may be in the form of an HTTP POST or GET message. Alternatively, the various merchants 212 may send the merchant promotional offer information to the server 204 in the form of an email, SMS message, or via any other communication protocol established between, and supported by, both the merchant 212 and the server 204.

According to some embodiments, upon receiving a request from the user 208 to provide a summary of the user's purchasing activity, the server 204 accesses stored transaction data 268 in the transaction database 244, parses the transaction data to identify data that corresponds to the user's request, and extracts the identified information. The server 204 then processes the identified information to generate 278 a summary of the user's purchasing activity. The server 204 then sends 282 said summary to any predetermined one or more of the user's mobile communication devices 250 for display 286 to the user 208.

Further, as illustrated in FIG. 2, according to some embodiments, upon receiving a request from the user 208 to provide promotional offers that may be of interest to the user, the server 204 accesses the promotional offers 272 in the promotional offer database 262, cross-references the promotion offer information with the user's transaction data in the transaction database 244 to determine which of the promotional offers correspond to purchases made by the user and that may therefore be of interest to the user. The server 204 then generates 278 a summary of the promotional offers that may be of interest to the user 208. The server 204 then sends 282 said summary to any predetermined one or more of the user's mobile communication devices 250 for display 286 to the user 208.

According to some embodiments, responsive to a request from a user to provide the user with one or more promotional offers that may be of interest to the user, the server 204 accesses payment transaction data of the user in the transaction database 244. The payment transaction data in the transaction data base 244, according to an embodiment, includes an item description for the payment transactions therein, where the item description describes an item the user purchased via the payment transaction. The server then accesses promotional offer data in the promotional offer database 262, where the promotional offer data includes an item description the promotional offers therein. Each of the item descriptions describes an item that corresponds to the promotional offer. The server 204, according to an embodiment, cross-references the item descriptions for the payment transactions with the item descriptions of the promotional offers to identify promotional offers that correspond to the items purchased by the user, and then provides to the user with the identified promotional offers. According to some embodiments, the request provided by the user includes filter criteria for identifying the promotional offers that may be of interest to the user. For example, the filter criteria include purchase amount ranges, item category descriptions, merchant identifiers, geographic areas of interest, and/or the like.

FIG. 3 is of another block diagram illustrating example aspects of systems and processes 300 for obtaining and presenting information related to user purchases and information related to promotions that may be of interest to users, according some embodiments. It should be appreciated that processes that are respectively described in FIGS. 2 and 3 can be used in combination or separately. A user 308 may desire to send purchase receipt information 320 to a transaction database 324 via a client device 328. In some example aspects, the client device 328 may be a user or consumer's web-enabled computer (e.g., laptop desktop, tablet, etc.) or a mobile communication device (e.g., PDA, smartphone, etc.). The transmitted purchase receipt information 320 is stored in the transaction database 324 along with transaction data associated with various other users or consumers. For example, the transaction database may receive (e.g., via one or more servers) transaction data from different entities such as, for example, issuers (e.g., user or consumer banks), acquirers (e.g., merchant banks), processing entities/Interchanges/payment processor institutions (e.g, VISA, CYBERSOURCE, PLAYSPAN, AUTHORIZE.NET, etc.). According to some embodiments, the purchase receipt information may be a confirmation email send from the merchant 312 to the user 308, and that the user 308 forwards via email to the transaction database 324 or that the user 308 forwards to a processing server 304 (hereinafter referred to as “server 304”), which then stores the confirmation email in the transaction database 324.

The transaction data 320 may include, but is not limited to, information corresponding to the user's purchasing activity, such as a description code (e.g., NAICS: North American Industry Classification System) associated with purchased items, cost of purchased items, and transactions. The transaction data may further include, but not be limited to, descriptions of the purchased items, payment accounts used to purchase items, indications of which purchases were made online, confirmation numbers, shipment statuses (e.g., order being processed, shipped, delivered, on back order, etc.), delivery tracking numbers, cancellation notices, updates, and/or the like. Still further, the transaction data 238 may include information regarding one or more of the user's communication devices 250 such as, but not limited to, the device name (e.g., Apple iPhone™, Motorola Droid™, etc.), means of communication adopted by each device (e.g., SMS message, Email, etc.), and a user-determinable device preference (e.g., Apple iPhone™ device) for establishing communications.

The server 304 may receive 344 and store 348 promotional offer information that corresponds to various goods or services from different merchants 312. For example, one merchant promotional offer may include “Merchant X: 20% reduction from the purchase of any laptop computer within the month of April.” According to another example, “Merchant Y: 6-months of free software and hardware support provided for any laptop computer purchased within the month of May.” For example, transmission of merchant promotional offer information between the merchants 312 and the server 304 may be in the form of an HTTP POST or GET message. Alternatively, the various merchants 312 may send the merchant promotional offer information to the server 304 in the form of an email, SMS message, or via any other communication protocol established between, and supported by, both the merchant 312 and the server 304. The server 304 may store the received merchant promotional offer information in a promotional offer database 352.

According to some embodiments, upon receiving a request from the user 308 to provide a summary of the user's purchasing activity, the server 304 accesses stored transaction data 356 in the transaction database 324, parses the transaction data to identify data that corresponds to the user's request, and extracts the identified information. The server 304 then processes the identified information to generate 368 a summary of the user's purchasing activity. The server 304 then sends 372 said summary to any predetermined one or more of the user's mobile communication devices 340 for display 376 to the user 308.

Further, as illustrated in FIG. 3, according to some embodiments, upon receiving a request from the user 308 to provide promotional offers that may be of interest to the user, the server 304 accesses the promotional offers 360 in the promotional offer database 352, and cross-references the promotion offer information with the user's transaction data in the transaction database 324 to determine which of the promotional offers correspond to purchases made by the user and that may therefore be of interest to the user. The server 304 then generates 368 a summary of the promotional offers that may be of interest to the user 308. The server 304 then sends 372 said summary to any predetermined one or more of the user's mobile communication devices 340 for display 376 to the user 308.

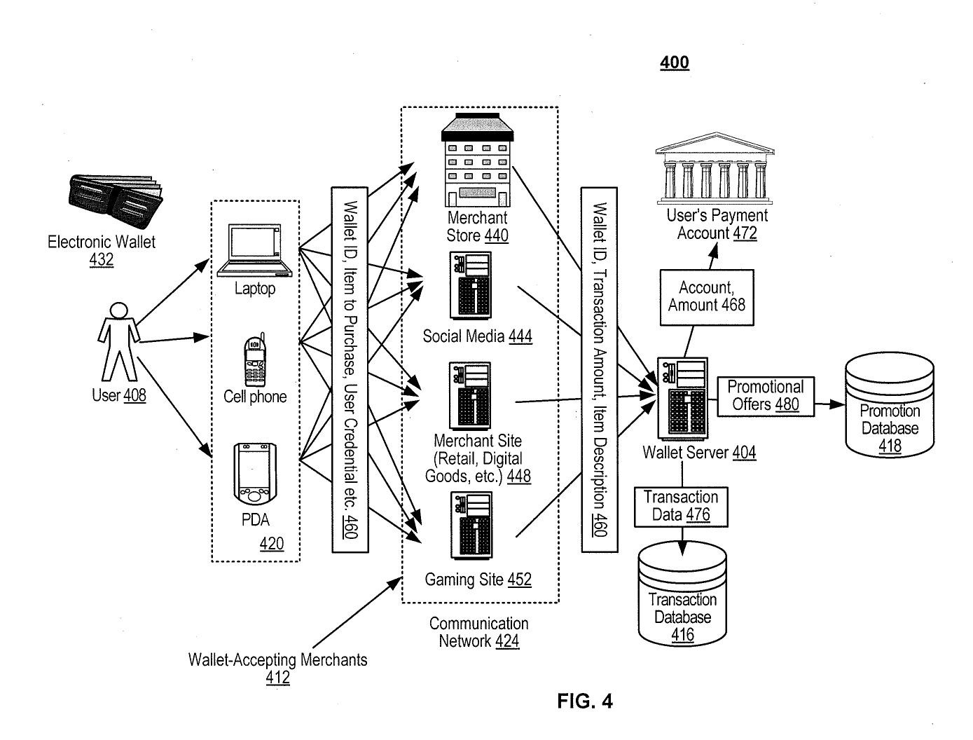

FIG. 4 is of a block diagram illustrating example aspects of systems and processes 400 for obtaining and presenting information related to user purchases and information related to promotions that may be of interest to users, according some embodiments. Within various embodiments, an electronic wallet server 404, a user 408, wallet-accepting merchants 412, a transaction database 416, and/or a promotion database 418 are shown to interact via communication network 424.

According to some embodiments, the user 408 may be associated with a wide variety of different communications devices 420 within embodiments of electronic wallet operation. For example, in one embodiment, the communications devices 420 may include, but are not limited to, terminal computers, work stations, servers, cellular telephony handsets, smart phones, PDAs, and/or the like. In one embodiment, the electronic wallet server 404 may be equipped at a terminal computer of the user 408. In another embodiment, the electronic wallet server 404 may be a remote server which is accessed by the user's 408 communications devices 420 via a communication network 424, such as, but not limited to local area network (LAN), in-house intranet, the Internet, and/or the like. In a further implementation, the merchant 412 may be integrated with a user 408 at a computer terminal.

In some embodiments, the user 408 may register an electronic “wallet” 432 with the electronic wallet server 404. For example, the user 408 may provide user profile information, payment information, bank account information, and/or the like to the electronic wallet server 404 to establish a record comprising the bank account information at the electronic wallet server. In some embodiments, a wallet-accepting merchant 412, such as a merchant store 440, a social media platform 444, a merchant shopping website 448, a gaming site 452, and/or the like, may register with the electronic wallet server 404, such that the electronic wallet server 404 may authorize the merchant 412 to engage a electronic wallet component to facilitate users to pay via the electronic wallet 432. For example, a social media platform 444, a merchant site 448, and/or the like, may comprise an icon of an electronic wallet on the shopping page, where the user 408 may click on the icon to pay for a transaction via the user's electronic wallet 432.

According to some embodiments, the user 408 may operate a personal device 420, such as a desktop, a laptop, a PDA, a smart phone and/or the like to access a wallet-accepting merchant 412, such as, but not limited to merchant store 440, a social media platform 444, a merchant shopping website 448, a gaming site 452, and/or the like. For example, the user 408 may open a webpage of Amazon.com, ebay.com, etc., to browse listed items for online shopping. When the user 408 is interested in buying an item, the user may click an “Add to Cart” button and/or an “Electronic Wallet Icon” (e.g., V.me by Visa) on the shopping page to indicate an intention of purchasing. For another example, the user 408 may access a social media platform 444, a gaming site 452, to purchase gaming points via wallet 432. The user 408 may submit user credentials 460, such as, but not limited to, the user's Wallet ID/User ID, password, and/or the like.

In some embodiments, when a merchant 412 receives from a user 408 an indication to engage in an electronic wallet payment along with the user's wallet credentials 460, the merchant 412 may forward the user's wallet credentials 460, a transaction amount, an item description, and/or the like to the electronic wallet server 404, which may verify the received wallets credentials 460 and proceed with payment processing. It should be appreciated that, upon selecting the wallet icon, the user 408 is directed to the electronic wallet server 404, where the user 408 provides the user's wallet credentials 460. In an example, the electronic wallet server 404 may retrieve from the wallet database 416 a registered user record based on the received credentials 460 and obtain previously registered user financial information, such as, but not limited to, a checking account, a credit card account, a PayPal account, and/or the like, and submit a fund transfer request, comprising an account number and an amount 468 to the user's financial account 472 via a financial network. The user's payment account 472 may process the fund transfer and return with a payment confirmation to the electronic wallet server 404 to indicate successful payment processing. Upon confirmation of payment, the electronic wallet server 404 may generate and store a transaction data 476 in the wallet database 416. In some embodiments, the electronic wallet server 404 may send the payment confirmation to the merchant 412, which may provide a confirmation page to the user 408 to complete the transaction.

According to some embodiments, the wallet-accepting merchant 412 may send transaction data 476 and other purchase transaction information to the wallet server 404. For example, the wallet-accepting merchant 412 may send such purchase transaction information to the wallet server 404, which may store the information in the transaction database 416, upon the user 408 selecting the electronic wallet icon, upon receiving payment confirmation from the electronic wallet server 404, and/or the like. Data in the transaction database 416 may include, but is not limited to, information corresponding to the user's purchasing activity, such as a description code (e.g., NAICS: North American Industry Classification System) associated with purchased items, cost of purchased items, and transactions. The data in the transaction database 416 may further include, but not be limited to, descriptions of the purchased items, payment accounts used to purchase items, indications of which purchases were made online, confirmation numbers, shipment statuses (e.g., order being processed, shipped, delivered, on back order, etc.), delivery tracking numbers, cancellation notices, updates, and/or the like. Still further, the data may include information regarding one or more of the user's communication devices 420 such as, but not limited to, the device name (e.g., Apple iPhone™, Motorola Droid™, etc.), means of communication adopted by each device (e.g., SMS message, Email, etc.), and a user-determinable device preference (e.g., Apple iPhone™ device) for establishing communications.

The wallet server 404 may receive and store promotional offer information 480 that corresponds to various goods or services from different merchants. For example, one merchant promotional offer may include “Merchant X: 20% reduction from the purchase of any laptop computer within the month of April.” According to another example, “Merchant Y: 6-months of free software and hardware support provided for any laptop computer purchased within the month of May.” For example, transmission of merchant promotional offer information between the wallet-accepting merchants 412 and the wallet server 404 may occur in the form of an HTTP POST or GET message. Alternatively, the various wallet-accepting merchants 412 may send the merchant promotional offer information to the wallet-accepting server 404 in the form of an email, SMS message, or via any other communication protocol established between, and supported by, both the wallet-accepting merchant 412 and the wallet server 404. The wallet server 404 may store the received merchant promotional offer information 480 in the promotional offer database 418.

According to some embodiments, the wallet server 404 generates summaries of the user's purchasing activity. For example, upon receiving a request from the user 408 to provide a summary of the user's purchasing activity, the wallet server 404 accesses stored transaction data and/or other purchase transaction data in the transaction database 416, parses the data to identify data that corresponds to the user's request, and extracts the identified information. The wallet server 404 then processes the identified data to generate a summary of the user's purchasing activity. The server 404 then sends said summary to any predetermined one or more of the user's communication devices 420 for display to the user 408.

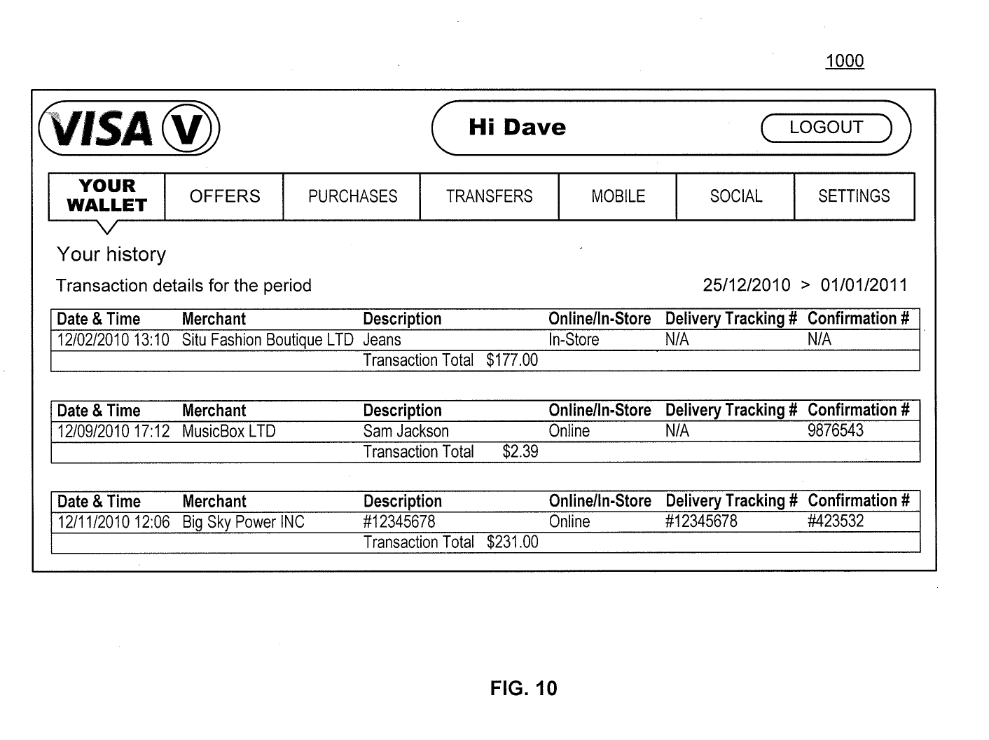

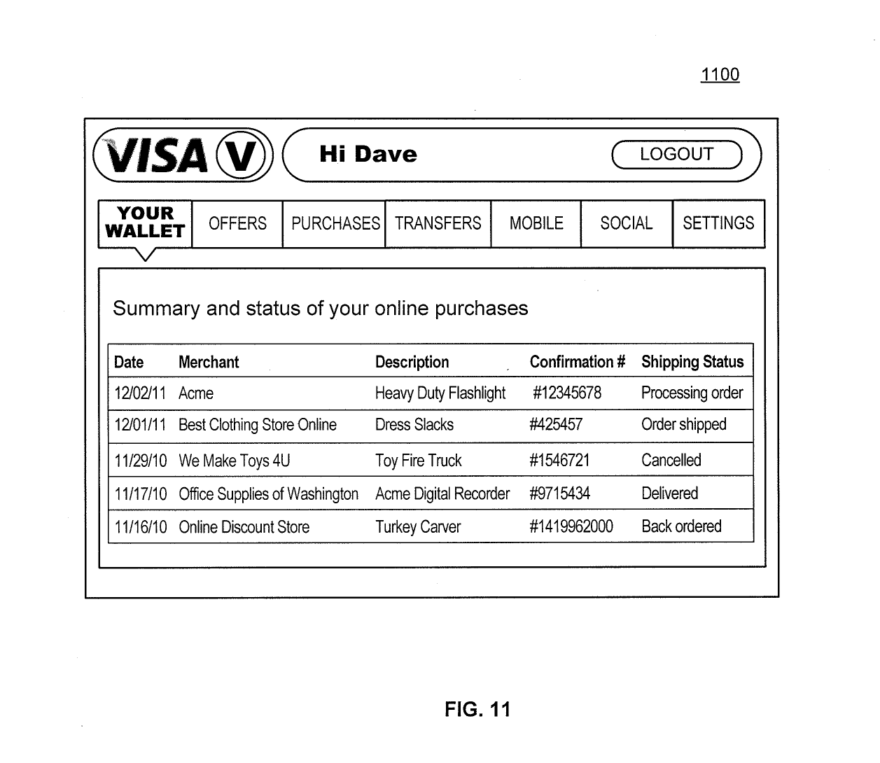

Screenshots of example summaries 1000 and 1100 are provided in FIGS. 10 and 11. The example summary 1000 of FIG. 10 is organized around individual purchase transactions, and, for each transaction, provides the date and time of the transaction, the merchant, a description of the purchased item, an indication of whether the purchase was made online or in-store, a delivery transaction number, and confirmation number. The example summary 1100 of FIG. 11 is also organized around individual purchase transactions and limited to online purchases. For example, to cause the wallet server 404 to generate summary 1100, the user 408 requests that the wallet server 404 provides a summary of recent online purchases. Responsive to such a request, the wallet server 404, for example, accesses stored transaction data and/or other purchase transaction data in the transaction database 418, parses the data to identify transactions that were made online (e.g., searches to identify merchants, such as by a merchant identifier, known to be online merchants, shipping data, codes indicating that the transaction involves an online purchase and/or the like), and extracts transaction data and/or other purchase data for the identified transactions. Then, using the extracted data, the wallet server 404 generates the summary 1100, which is organized around individual purchase transactions and which includes the following data fields: the date of the transaction; the merchant identifier; a description of the purchased item; a confirmation number; and a shipping status (e.g., processing order, order shipped, delivery confirmed, canceled, on back order, etc.).

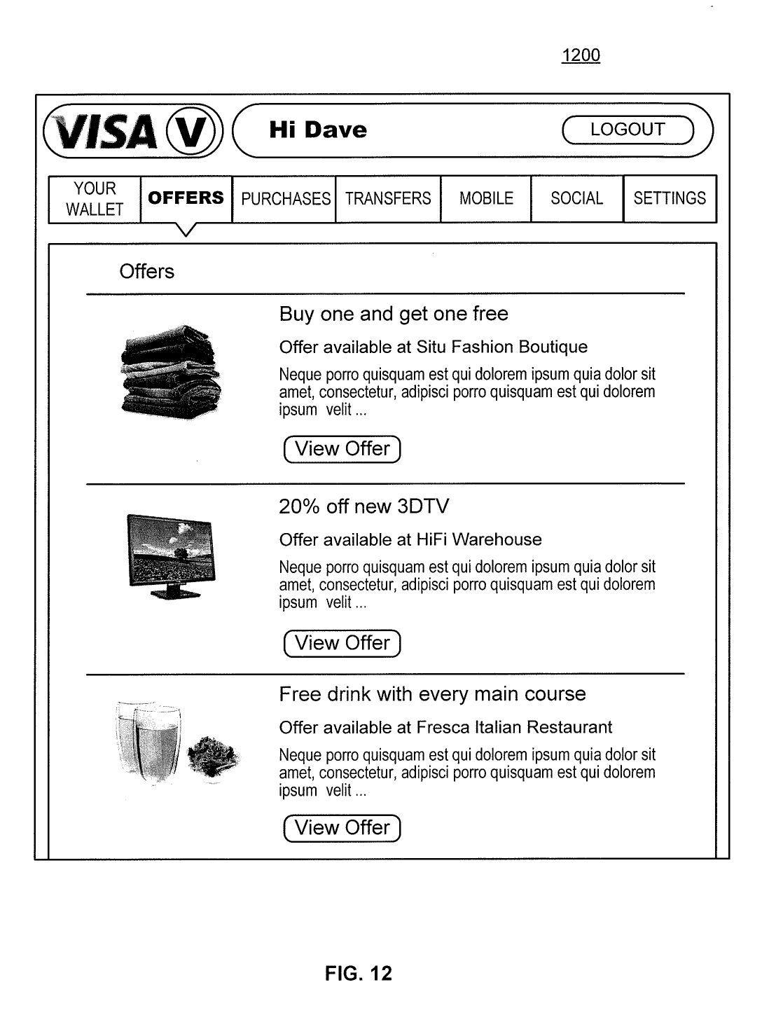

Further, as illustrated in FIG. 4, according to some embodiments, the wallet server 404 provides the user 408 with a summary of promotional offers that may be of interest to the user. To do so, for example, the server 404 accesses the promotional offers in the promotion database 418, cross-references the promotion information with the user's transaction data in the transaction database 416 to determine which of the promotional offers correspond to purchases made by the user and that may therefore be of interest to the user. The wallet server 404 then generates a summary of the promotional offers that may be of interest to the user 408. The wallet server 404 then sends said summary to any predetermined one or more of the user's communication devices 420 for display to the user 408. A screenshot of an example summary 1200 is provided in FIG. 12. The example summary 1200 lists offers that may be of interest, for example, based on the user's recent purchasing activity. For example, the promotional offers provided in screenshot 1200 are for items and/or merchants that the user 408 has recently purchased and/or made purchases from.

In some embodiments, the electronic wallet server 404 may communicate with the wallet database 416; in other embodiments, the electronic wallet server 404 may be integrated with the wallet database 416. In other embodiments, wallet database 416 may be remote from the electronic wallet server 404, which may access the wallet database 416 via the communication network 424. The electronic wallet server 404 may send the information to the wallet database 416 for storage, such as, but not limited to, user account information, transaction record information 476, such as order record information, payment record information, and/or the like.

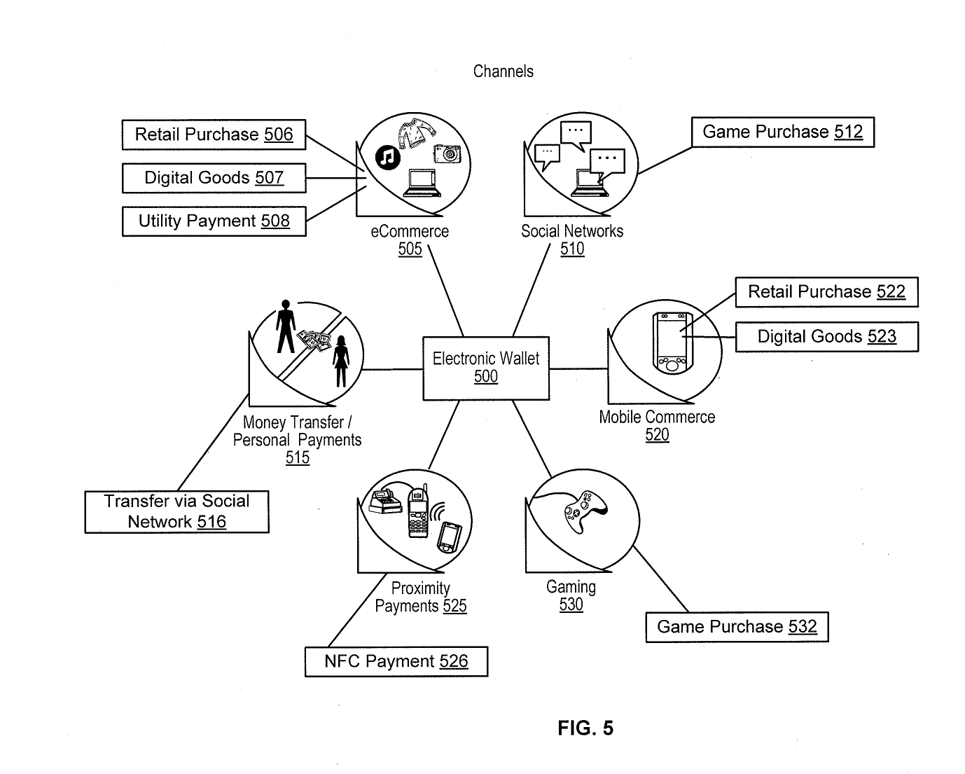

FIG. 5 provides a block diagram illustrating embodiments of an electronic wallet 500. The electronic wallet 500 may be used in a variety of transactions, such as but not limited to eCommerce 505, social networks 510, money transfer/personal payments 515, mobile commerce 520, proximity payments 525, gaming 530, and/or the like. For example, users may engage in eCommerce via the electronic wallet 500 for retail purchases 506, digital goods purchases 507, utility payments 508, and/or the like. Users may also, for example, use the electronic wallet 500 to purchase games 512 or gaming credits 532 from gaming websites, transfer funds to friends via social networks 516, and/or the like. Further, for example, users may also use the electronic wallet 500 on a smart phone for retail purchases 522, buying digital goods 523, and NFC/RF payments 526 at POS terminals.

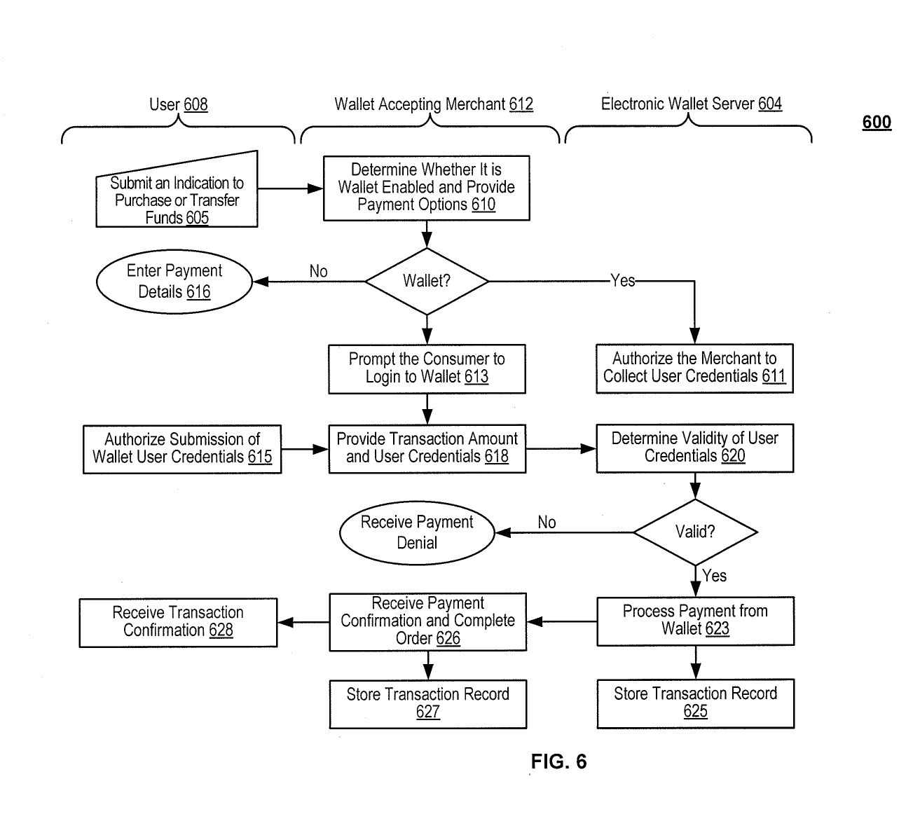

FIG. 6 provides a logic flow diagram 600 illustrating payment processing within embodiments of an electronic wallet, according to some embodiments. As illustrated, a user 608 may submit an indication to purchase or transfer funds 605. For example, the user 608 may visit a merchant website, e.g., Facebook.com, Amazon.com, etc., and request to purchase an item from the website, transfer funds to a friend, and/or the like. The merchant website 612 may determine whether the electronic wallet is authorized on its website, and may provide a list of payment options 610. If the merchant 612 is registered with a electronic wallet server 604, the electronic wallet server 604 may authorize the merchant 612 to collect user credentials for login to the electronic wallet 611, and the merchant website may prompt the user 608 to login to the electronic wallet 613. Otherwise, the merchant website may request the consumer to provide payment details for alternative payment options, e.g., credit card, debit card, PayPal account, and/or the like 616.

The user 608 may authorize submission of his wallet user credentials 615, such as, but not limited to, a Wallet/User ID, a password, and/or the like. For example, the user 608 may enter the Wallet/User ID and password into a pop-up window provided from the merchant website and/or electronic wallet server 604. In another example, the user 608 may authorize the merchant website to provide the user credentials, e.g., previously stored in HTML5, cookies, etc., to the electronic wallet server 604. In yet another example, the user 608 may authorize the electronic wallet server 604, via a remote component running on the merchant website (e.g., a Java applet, etc.) to provide user credentials to the electronic wallet server for verification.

When the user submits user credentials to log into electronic wallet 615, the merchant website may forward the user credentials and transaction details 618 to the electronic wallet server 604, which may determine the validity of the user credentials 620. If the user's credentials are not valid, the electronic wallet server 604 may deny the payment request and send a notification of denial to the merchant website. In other embodiments, if the user-provided credentials are valid, the electronic wallet server 604 may process payment from the electronic wallet 623. For example, the electronic wallet server 604 communicates with the user's bank account associated with the electronic wallet and requests a fund transfer of an indicated amount. The electronic wallet server 604 may then store a transaction record 625.

In some embodiments, after processing the payment, the electronic wallet server 604 sends a payment confirmation notice to the merchant website, which in turn completes the order 626 and stores the transaction record 627 in the database. The merchant website may provide a confirmation page comprising transaction confirmation to the consumer 628.

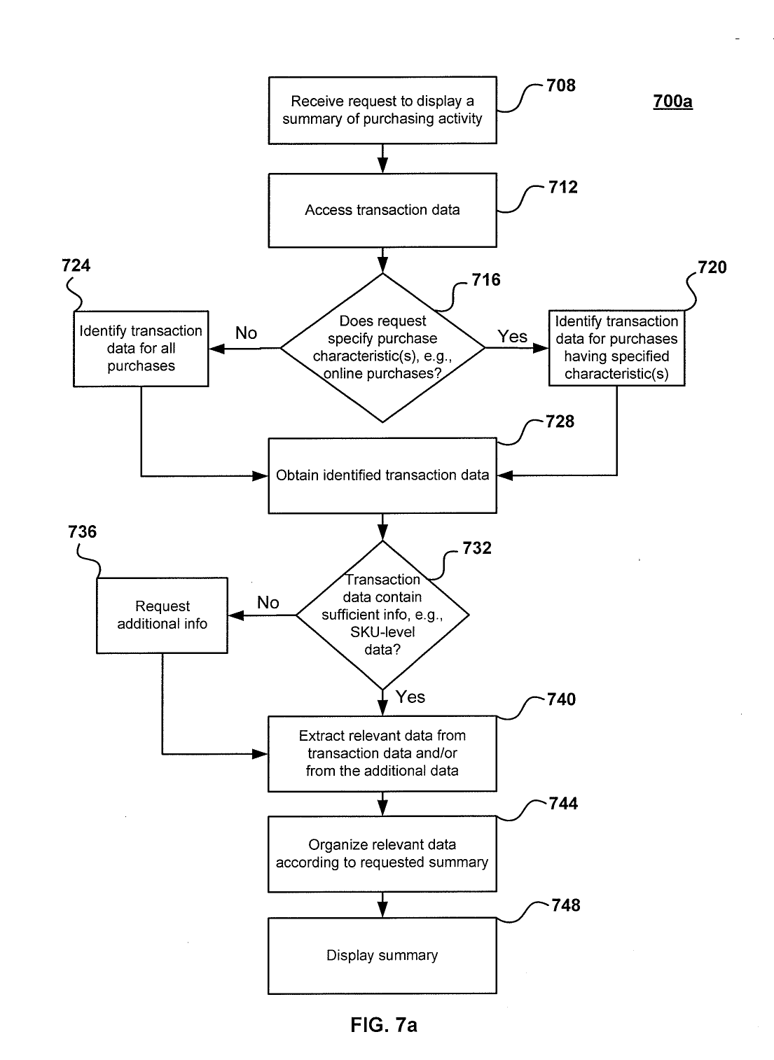

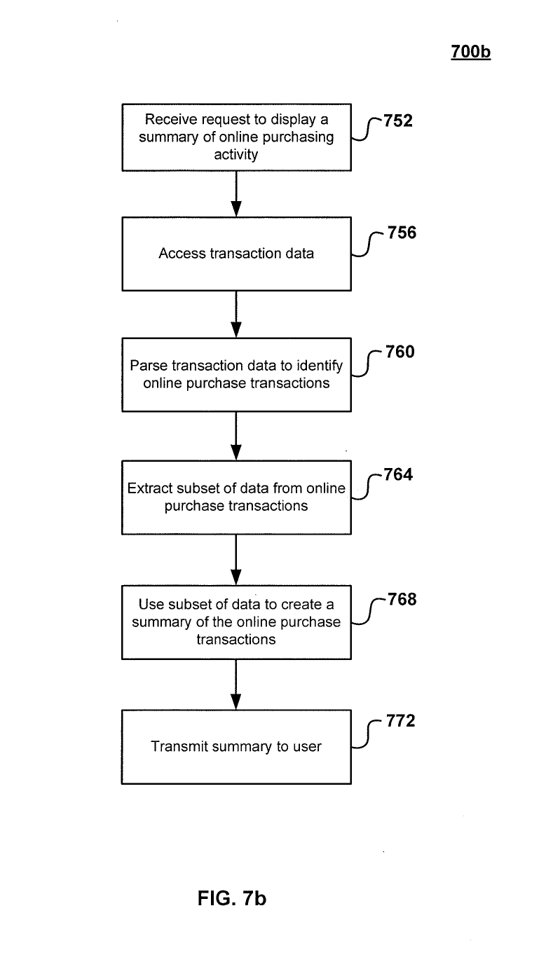

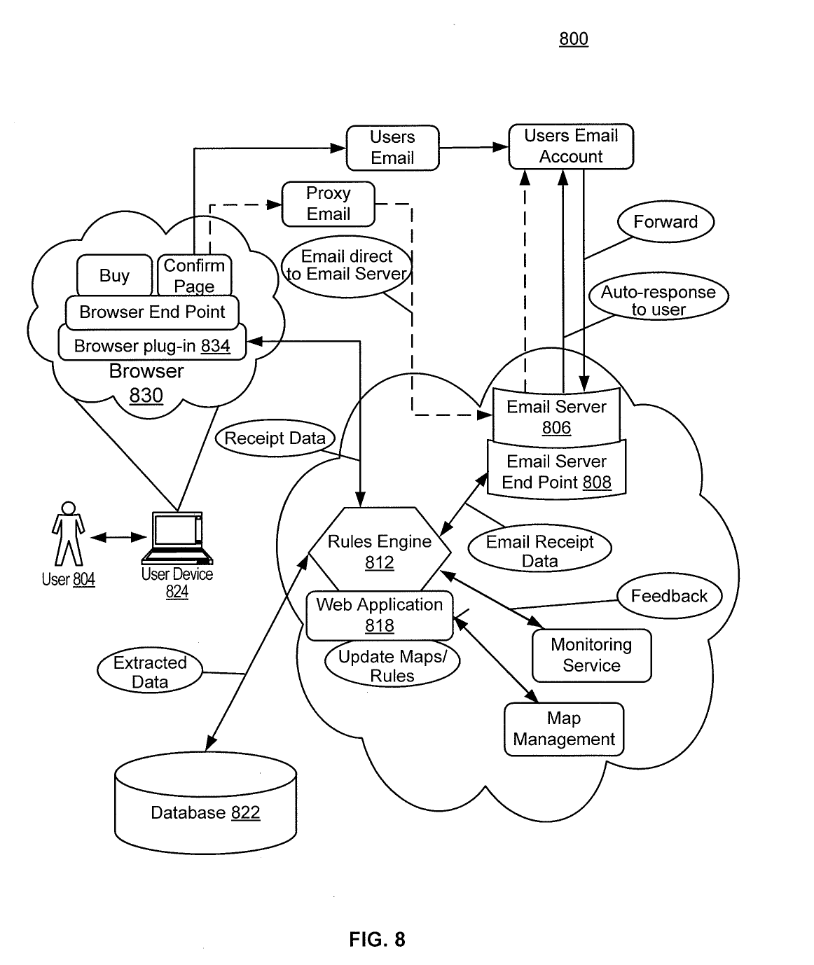

FIG. 7a is a block diagram illustrating example aspects of a process 700a for obtaining, organizing, and presenting summaries of information related to a user's purchases, according some embodiments. For illustrative convenience, process 700a is described as being implemented by the server 204 of FIG. 2. However, it should be appreciated that process 700a can be implemented by the server 304 of FIG. 3, by the wallet server 404 of FIG. 4, and by the system 800 of FIG. 8.

Block 708 involves receiving a request to display information relating to a user's purchasing activity. For example, according to block 708, the user 208 sends a request via the client 220, which can be one of the user's communication devices 250, to the server 204. In this example, the request instructs the server 204 to display to one of the user's communication devices 250 a summary of the user's purchase transactions. Block 712 involves accessing transaction data. For example, the server 204 may access the purchase transaction data that is stored in the transaction database 244 and that is associated with the user 208.

Block 716 involves determining whether the request specifies one or more purchase characteristics (e.g., purchase characteristics that define a purchase type, such as online purchases). If so, the summary of the user's purchase activity is limited to purchases having the specified characteristic(s). For example, a user 208 interested in seeing a summary of his online purchasing activity can specify “online” as a characteristic in the request. In this case, the server 204 will only include online purchases in the summary. The user 208 may specify other purchase characteristics, such as geographic location, price range, date range, payment account(s) used, merchant name/identifier, merchant category, product or service category, product or service name, and/or the like.

Referring now to block 720, if the request includes one or more purchase characteristics, the process 700a involves identifying transaction data for purchases having the one or more specified characteristics. For example, the server 204 searches the transaction data stored in the transaction database 244 to identify transactions having the specified one or more characteristics. However, as indicated at block 724, if the request does not specific a purchase characteristic, then the process 700a proceeds to block 724, which involves identifying transaction data for all purchases. In this case, for example, the server 204 searches the transaction data stored in the transaction database 244 to identify all purchase transactions. It should be appreciated that the transaction data identified at block 724 may be limited to a pre-defined date range, such as the previous three months. Block 728 involves obtaining identified transaction data. For example, according to block 728, the server 204 obtains the transaction data that was identified at block 720 or 724.

Block 732 involves determining whether the obtained transaction data contains sufficient information. For example, block 732 involves determining whether the data obtained according to block 728 includes enough information to satisfy a user's request for a summary of the user's purchasing activity. This determination varies depending on the requested summary. For example, if the request is for a summary that includes “date of purchase”, “merchant identifier”, and “purchase amount”, then at block 732, the obtained transaction data is reviewed to determine whether the requested data fields are included in the data. Further, for example, if the request is for a summary that includes “a description of the purchased item,” “an indication of whether the purchase was an online or in-store purchase”, “confirmation number”, “shipment status”, and/or “delivery tracking number”, then at block 732, the obtained transaction data is reviewed to determine whether the requested data fields are included in the data.

If the obtained transaction data does not include sufficient information (e.g., does not include requested data fields), the process 700a proceeds to block 736, which involves requesting additional data. For example, if the data fields (e.g., “confirmation number”, “item description”) required to generate the requested summary are not available in the transaction data obtained from the transaction database 244, the server 204, according to block 736, requests the needed data fields from another entity, such as the merchant where the transaction occurred, the issuing or acquiring bank, the entity that processed the transaction, and/or the like. If the obtained transaction data does include sufficient information or after additional information is obtained, the process 700a proceeds to block 740, which involves extracting relevant data from the transaction data and/or from the additional data. For example, at block 740, the server 204 extracts transaction data that corresponds to the data fields that are to be included in the requested summary.

Block 744 involves organizing the relevant data according to the requested summary. In some embodiments, the user request received at block 708 may be a request to provide a transaction-by-transaction summary of purchases having one or more purchase characteristics, where the summary is to include selected data fields. For example, the screenshot of summary 1100 in FIG. 11 is an example of a summary generated by the server 204, according to process 700a, in response to a user-request for a transaction-by-transaction summary of the user's online purchases made in the last month, where the requested summary is to include the following data fields: “date of purchase”, “merchant name/identifier”, “item description”, “confirmation number”, and “shipment status”. It should be appreciated that, in addition to server 204, servers 304 and 404 could have executed process 700a to generate summary 1100. Block 748 involves displaying the summary of the purchasing activity. For example, at block 748, the server 204 sends the summary to one of the user's communication devices 250 for display.

FIG. 7b is a block diagram illustrating example aspects of another process 700b for obtaining, organizing, and presenting summaries of information related to a user's purchases, according some embodiments. For illustrative convenience, process 700b is described as being implemented by the server 204 of FIG. 2. However, it should be appreciated that process 700b can be implemented by the server 304 of FIG. 3, by the wallet server 404 of FIG. 4, and by the system 800 of FIG. 8.

Block 752 involves receiving a request from a user to generate a summary of the user's online purchases. For example, the user 208 sends such a request to the server 204 via one of the user's communication devices 250. Block 756 involves accessing payment transaction data. For example, according to block 756, the server 204 accesses the user's payment transaction data, which is stored in the transaction database 244. According to some embodiments, the user's payment transaction data in the transaction database is related to a plurality of payment transactions made by the user 208 using one or more of the user's payment accounts. Further, according to some embodiments, for each of the user's individual payment transactions, the payment transaction data includes a merchant identifier, a purchase amount, a purchase date, a confirmation number, a shipment status, a shipment tracking number, and an item description.

Block 760 involves parsing the payment transaction data to identify one or more online purchase transactions from among the plurality of individual payment transactions. For example, according to block 760, the server 204 parses the payment transaction data that it accesses in or that it retrieves from the transaction database 244 to identify the user's online purchase transactions from among some or all of the user's payment transactions. To do so, for example, the server 204 parses the payment transaction data to obtain merchant identifiers for some or all of the plurality of payment transactions and then compares the obtained merchant identifiers to a list of merchant identifiers for known online merchants. For example, the list may be accessible to the server 204, and the list may include online merchants and/or merchants that sell items/services online and a merchant identifier that corresponds with each of the merchants. When one of the merchant identifiers obtained from the user's transaction data in the transaction database 244 matches one of the merchant identifiers on the list, then the server 204 identifies the payment transaction as an online purchase transaction.

Block 764 involves extracting a subset of data from the one or more online purchase transactions. For example, according to block 764, the server extracts a subset of data from the data in the transaction data base 244 that is associated with the user's 208 online purchase transactions. For example, for each online purchase transaction, the subset of data may include a merchant identifier, a purchase amount, a purchase date, a confirmation number, a shipment status, a shipment tracking number, and an item description. At block 768, the process 700b involves using the subset of data to create a summary of the one or more online purchase transactions. Here, for example, the server 204 may use the subset of data to create a summary of the user's 208 online purchases. An example of such a summary is provided in FIG. 11, which provides a screenshot of summary 1100. Summary 1100 is organized around the user's individual purchase transactions and is limited to online purchases. According to some embodiments, the summary, for each of the online purchase transactions, includes the purchase amount, the purchase date, the merchant identifier, and at least one of the item description, the confirmation number, the shipment status, and the shipment tracking number. Further, according to some embodiments, the summary of the one or more online purchases is created according to a request submitted by the user, where the request includes filter criteria for identifying the one or more online purchases to be included in the summary. For example, the filter criteria could include at least one of a purchase date range, a purchase amount range, one or more merchant identifiers, a shipping status, and a payment account used. Block 772 involves transmitting the summary to a communication device of the user. For example, the server 204, according to block 772 transmits the summary to one of the user's communication devices 250.

FIG. 8 is of a block diagram illustrating example aspects of systems and processes 800 for obtaining, organizing, and presenting information related to user purchases, according some embodiments. The systems and processes 800 may also be capable of obtaining and presenting information related to promotions that may be of interest to users. It should be appreciated that systems and process 800 of FIG. 8 may generate summaries of user's purchasing activity, such as the example summaries 1000 and 1100 of FIGS. 10 and 11. It should also be appreciated that systems and process 800 of FIG. 8 may generate summaries of promotional offers that may be of interest to the user, such as the example summary 1200 of FIG. 12. The illustrated system includes an email server 806 that receives emails from and by users 804 and/or merchants. The email may include for example, confirmation information related to user purchases, updates and notices regarding purchases, promotional offers, and/or the like. In one example, upon making an online purchase from a merchant and receiving a confirmation email from the merchant, the user forwards the confirmation email to the email server 806. The email confirmation may include information, such as the user's name, the merchant's name, the product name and price, a confirmation code, shipping information etc. According to an embodiment, the email server 806 organizes the confirmation emails on a transaction-by-transaction basis. Thus, if the email server 806 receives a first email about a purchase transaction and later receives a second email about the same transaction, then the email server 806 appends the second email to the first. In another example, the merchant emails promotion offers to the user, who then forwards the emails to the email server 806. According to an embodiment, the email server 806 can organize promotions offers around the relevant merchant, product, and/or the like.

The illustrated system 800 further comprises an email server endpoint 808 that is securely connected to the email server 806 and that reacts to the receipt of incoming emails by invoking mapping rules stored in a rules engine 812 to parse the incoming emails. The resulting actions of the mapping rules include the posting of parsed data to a web application 818 and the transmission of directives from the web application 818 back to the email server 806 to manage the email. The web application 818 determines what to do with parsed data and what response, if any, to send to the user 804.

The web application 818, according to some embodiments, is configured to provide a data persistence layer for data parsed out of user-forwarded emails. For example, the web application 818 determines what to do with parsed data, such as whether to append the data to an existing transaction or create a new transaction. Further, for example, the web application 818 generates responses to the user and provides data persistence for features, such as wish space and form fill. According to an embodiment, the web application 818 exposes APIs to connecting systems and provides management interfaces to program administrators.

The email server endpoint 808, according to an embodiment, is configured to serve as the integration layer between the email server 806 and the web application 818. To do so, for example, the email server endpoint 808 determines when a new email arrives at the email server 806 and then sends the email to the web application 818 for parsing. According to an embodiment, the email server endpoint 808 is an IMAP client that detects and downloads emails from the email server 806 and then invokes the web application 818 through an evaluation API. Further, for example, the email server endpoint 808 receives directive files encoded with instructions from the web application 818 and then executes the instructions on the email server 806. Such instructions include sending notification emails to a user 804 in response to receiving an email from that user.

According to an embodiment, the web application 818 is associated with the rules engine 812, which is a web application configured to provide email-parsing-map management and evaluation capabilities. According to an embodiment, the rules engine 812 provides an interface for map administrators to add, create, edit, or delete email parsing maps. It should be appreciated that the web application 818 and the rules engine 812 may be separate or combined. The rules engine 812 may also serve as a reporting interface for rule execution. The service, when invoked by the email server endpoint 808 upon receipt of an email, applies relevant parsing maps to extract the desired data from the emails and send the extracted data to a database 822. According to an embodiment, the particular parsing map applied to an incoming email may be selected based on email origination and subject line pattern matching.

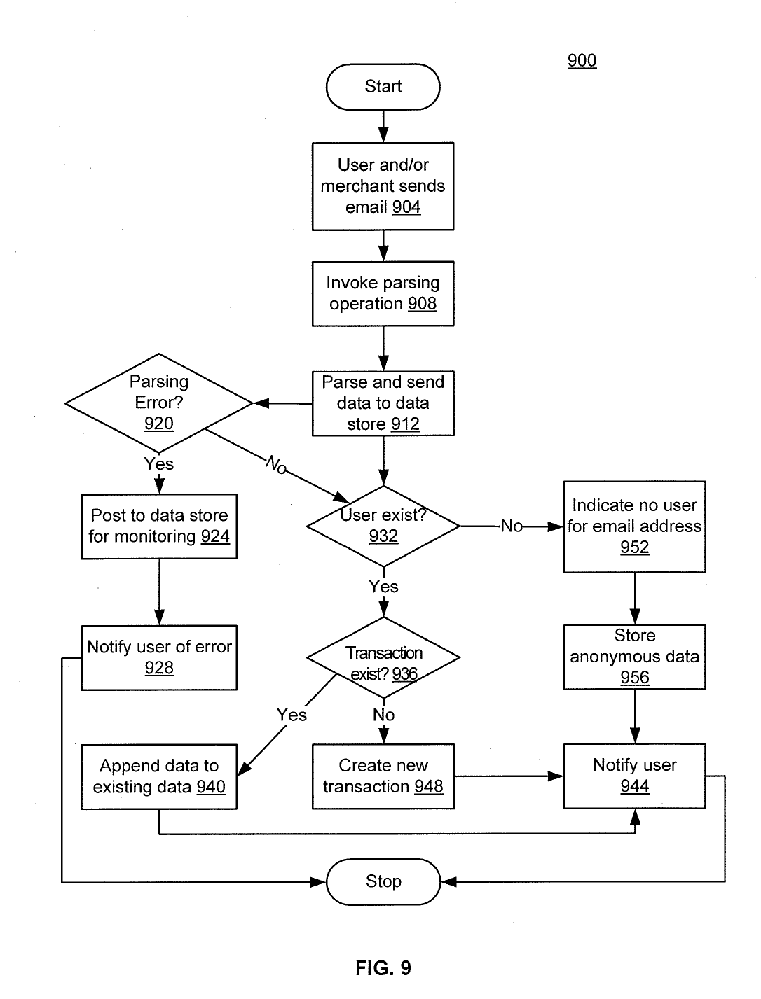

FIG. 9 is a block diagram illustrating example aspects of a process 900 for obtaining, organizing, and presenting information related to a user's purchasing activity and promotional offers, according some embodiments. For illustrative convenience, the process 900 is described herein as being implemented using the system 800 of FIG. 8. It should be appreciated, however, that process 900 can be implemented by the server 204 of FIG. 2, the server 304 of FIG. 3, and by the wallet server 404 of FIG. 4.

As indicated at block 904, the process 900 generally begins with a user and/or a merchant sending an email, where the email is related to an online purchase and/or a promotional offer. For example, the email may be a confirmation email sent from the merchant to the user in response to the user making an online purchase from the merchant. In this case, for example, the user forwards the merchant confirmation email to the email server 806. As indicated at block 908, the method 900 further involves detecting the arrival of the email and invoking an email parsing operation. For example, upon the email server endpoint 808 detecting the arrival of a new email, the web application 818 applies a parsing rule to extract relevant information from the email.

As indicated at block 912, the method 900 involves parsing data from the email and sending the data to a data store. For example, to parse data from emails, the web application 818 may convert the email to text and then evaluate the original from address to determine the merchant and/or the user. The web application 818 may also evaluate the subject line to glean more information about the purchase and/or the promotional offer that is the subject of the email. After evaluating the original from address and the subject line, the web application 818 determines whether an applicable parsing map exists. For example, if the original from address is “Acme Online Merchant” and the subject line and/or body of the email contains “Widget X,” then the web application 818 searches for a parsing map designed for Acme Online Merchant and/or Widget X.

If a parsing map exists, the web application 818 applies the parsing map to parse out relevant data. For example, the web application 818 may apply the parsing map to identify clusters of text in the email and parse out relevant clusters. For example, the web application 818 may identify and parse out clusters of text that represent the merchant identifier/name, the product description, the confirmation code, the price, the shipping/delivery date, the mail carrier's tracking number, etc. If more than one parsing map exists (e.g., there is one map for purchase confirmations involving the merchant and product, and another for promotional offers involving the merchant and product), the web application 818 selects the map that corresponds most closely to the test of the email. If no parsing map exists for the original sender/subject line, then the web application 818 attempts to parse out relevant data anyway. After applying the parsing map to parse out data from the email, the web application 818 sends the parsed data to the database 822. It should be appreciated that purchase transaction data obtained from confirmation emails and promotional offers data obtained from promotional emails could be stored in separate databases, such as the transactional and promotional offer databases 244 and 262 of FIG. 2.

As indicated at decision block 920, the system 800 determines whether an error occurred during parsing. For example, the web application 818 determines whether an error occurred during parsing. If so, the parsed data is posted to a database for monitoring, and the user 808 is notified of the error, as indicated at blocks 924, 928. For example, the web application 818 instructs the email server 806 to notify the user 808 of the email server, and then posts the data to the database 822. However, if no error occurred during parsing, a determination is made as to whether a record exists for the user 828, as indicated at block 932. For example, the web server 818 determines whether the database 822 has an existing record for the user. If a record exists, as indicated at block 936, a determination is made as to whether a record already exists for the particular online purchase or promotional offer, which is the subject of the email. As indicated at decision block 940, if a record already exists for the online purchase or promotional offer, the data is appended to the existing record and then, as indicated at block 944, the user 808 is notified. However, if a record does not already exist, a new record is created and the data is stored therein, as indicated at block 948.

Referring again to decision block 932, if it is determined that a record does not already exist for the user, then, as indicated at block 952, a reply email is sent to the user 808, indicating that no record exists for the user 808. For example, if no record exists, thereby indicating that the user 808 has not created an account and signed up for the services provided by the example system 800 of FIG. 8, then an application associated with the database 822 sends the appropriate response message to the web application 818. The web application 818 then encodes a directive file with the appropriate message and email handling instructions, and sends the directive file to the email server 806. The email server 806 executes the directive file to obtain the email handling instructions and to generate and send the appropriate response message to the user 808 via an email. As indicated at block 956, if no record exists, the parsed data is stored nonetheless and, as indicated at block 944, the user 808 is notified that no record exists for the user 808.

It should be appreciated that the processes described herein may be implemented using a plug-in installed on a web browser of a client device. For example, with reference to FIG. 8, a browser plug-in 834 installed in a browser application 830 of the device 824 of the user 804 is configured with program code for receiving transaction data, organizing the transaction data, and presenting the transaction data to the user 804 according to the examples described herein. According to some embodiments, a user 804 wishing to view a summary of his online purchases, may access the user 824 and invoke the browser plug-in 834 to obtain parsed transaction data associated with the user 804 from the database 822. The browser plug-in 834, after obtaining the transaction data, may then present a summary of the transaction data to the user 804 via the user device 824.

FIG. 13 is a diagram illustrating the components and operation of a payment processing network that may be used in implementing embodiments of the invention. FIG. 13 shows a user (typically a consumer) 1304, a merchant 1306, an acquirer 1310, a payment processing network 1314, and an issuer 1316. Acquirer 1310 and issuer 1316 can communicate through payment processing network 1314. The merchant 1306 includes at least one point of service (POS) terminal 1308 and can communicate with acquirer 1310, payment processing network 1314, and issuer 1316.

User 1302 may be a consumer of goods and/or services. User 1302 may be associated with (e.g., use) a portable consumer device 1304 that is used to make a payment for goods, products, or services. Example portable consumer devices 1304 include credit cards, debit cards, and prepaid cards (e.g., gift cards or payroll cards). Portable consumer device 1304 may also be in a form factor other than a card. For example, portable consumer device 504 may be hand-held and compact so that it can fit into a consumer's wallet and/or pocket (e.g., pocket-sized). Examples of portable consumer devices may include cellular phones, personal digital assistants (PDAs), pagers, security cards, access cards, smart media, transponders, and the like. The portable consumer devices may interface with point of service (POS) terminals using any suitable mechanism including any suitable electrical, magnetic, or optical interfacing system. For example, a contactless system such as an RF (radio frequency) device recognition system or contact system such as a magnetic stripe may be used to interface with a POS terminal containing a contactless reader or a magnetic stripe reader, respectively.

Merchant 1306 can be one of many merchants. For example, merchant 1306 may be a merchant with one or multiple POS terminals and/or websites for accepting payment. Exemplary merchants can include online stores, retail stores, drugstores, grocery stores, gas stations, hardware stores, etc. Merchants 1306 can include businesses that do not have an affiliation with each other, and may simply be a business that has normal POS terminals or a website configured to process credit card or debit card transactions. Merchant 1306 may have any suitable number and/or type of POS terminals. Suitable POS terminals include stand-alone kiosks, check-out lanes or check-out counters at merchants, etc. Suitable POS terminals may include terminals that are configured to process credit card or debit card transactions. The POS terminals may have optical, electrical, or magnetic readers that can read data from portable consumer devices.

As shown in FIG. 13, the overall system may include an Acquirer 1310 and an Issuer 1316. Acquirer 1310 may be a commercial bank that is associated with merchant 1306. Merchant 1306 may have one or more Acquirer deposit accounts 1312. Issuer 1316 is an entity that provides the user with the portable consumer device and manages the account or accounts associated with the device and/or provides the user with one or more payment accounts that the user may make purchases against using communications devices and/or electronic wallets over a network.

Payment Processing Network 1314 may comprise or use a payment processing network such as VisaNet™. Payment Processing Network 1314 and any communication network that communicates with Payment Processing Network 1314 may use any suitable wired or wireless network, including the Internet. Payment Processing Network 1314 may be adapted to process debit card or credit card transactions, in addition to processing transactions associated with the loading and/or reloading of value on a payment device or portable consumer device.

As noted, a payment processing network (e.g., VisaNet) may include a plurality of data processing devices, such as computers, servers, or central processing units that are interconnected by a suitable network or networks. The data processing devices may be used to support authorization, clearing, and settlement services for users of the payment processing network, where these services may be applied as needed to various types of transactions and typically are described as:

Authorization—the necessary functions or operations to enable an issuer to approve or decline a transaction before a purchase is finalized or cash is disbursed;
Clearing—the necessary functions or operations to support the process of delivering a transaction from an acquirer to an issuer for posting to a consumer's account; and
Settlement—the necessary functions or operations to support the process of calculating and determining the net financial position of each party for all transactions that are cleared.

The authorization, clearance, and settlement functions are typically performed by exchanging messages between the elements of the payment processing network and the entities that interact with that network (such as the acquirer and issuer). Depending on the function being performed and the type or format of a message, a message may contain information about the transaction (e.g., the date, type of transaction, amount of transaction, merchant, etc.), information about the consumer conducting the transaction (e.g., the consumer's account number, security code, etc.), information about the merchant with whom the consumer is conducting the transaction (e.g., a merchant code or other identification, etc.), and information about the status of the processing of the transaction (e.g., a flag or indicator of whether the transaction has been approved or declined, etc.). A message may also include information about the transaction that is used by the elements of the payment processing network and/or the entities that interact with that network to perform their respective data processing functions (e.g., a risk or fraud score, etc.). The messages typically have a format or structure in which certain information is found in a defined field or region of the message. In addition to one or more defined fields, a message may also include one or more discretionary fields in which other forms or types of data may be placed.

In a payment processing network such as VisaNet, the primary components are VisaNet Interchange Centers (VICs), VisaNet Access Points (VAPs) and other network connections, and Processing Centers. These components are arranged in an architecture that provides consumers, merchants, acquirers, and issuers with the services needed for authorization, clearance, and settlement of transactions.

A VisaNet Interchange Center (VIC) is a Visa data processing center. Each VIC houses the computer systems that perform VisaNet transaction processing. The VIC serves as the control point for the telecommunications facilities of the VisaNet Communications Network, which comprises high-speed leased lines or satellite connections based on IBM SNA and TCP/IP protocols.

A VisaNet Access Point (VAP) is a Visa-supplied computer system (located at a processing center) that provides the interface between the center's host computer and the VIC. The VAP facilitates the transmission of messages and □les between the processing center host and the VIC, supporting the authorization, clearing, and settlement of transactions. Visa also provides other connection options for interacting with VisaNet that do not require VAPs.

A processing center is a data processing facility operated by (or for) an issuer or an acquirer. The processing center houses card processing systems that support merchant and business locations and maintain cardholder data and billing systems. As a form of redundancy, each processing center communicating with VisaNet is linked to two VICs. Processing centers are connected to the closest, or primary, VIC. If one VIC experiences system interruptions, VisaNet automatically routes members' transactions to a secondary VIC, ensuring continuity of service. Each VIC may also be linked to one or more of the other VICs. This link enables processing centers to communicate with each other through one or more VICs. Processing centers can also access the networks of other card programs through the VIC.

A VisaNet Interchange Center typically houses the following VisaNet systems that provide both online and of □ine transaction processing:

(1) the VisaNet Integrated Payment (V.I.P.) System, which includes the BASE I System and the Single Message System (SMS);

### (2) the BASE II System; and

### (3) the VisaNet Settlement Service (VSS).

Together, these VisaNet systems perform part or all of the transaction authorization, clearing, and settlement functions.

The V.I.P. System is the primary online transaction switching and processing system for all online authorization and financial request transactions that enter VisaNet. V.I.P. has one system that supports dual-message processing (authorization of transactions is requested in a first message, while financial clearing information is sent in a second message), and another system that supports single-message processing (the processing of interchange card transactions that contain both authorization and clearing information in a single message). In both cases, settlement occurs separately.

BASE I is the component of the V.I.P. System that processes authorization-only request messages online. Authorization request messages are typically the □rst messages sent in dual-message processing (where BASE II clearing messages are the second messages sent in dual-message processing). The BASE I component of the V.I.P. System supports online functions, offline functions, and the BASE I □les. BASE I □les include the internal system tables, the BASE I Cardholder Database, and the Merchant Central File. The BASE I online functions include dual-message authorization processing. BASE I online processing involves routing, cardholder and card verification, and stand-in processing (STIP), plus related functions, such as Card Verification Value (CVV) validation, PIN verification, and □le maintenance.

A bridge from BASE I to SMS makes it possible for BASE I members to communicate with SMS members and to access the SMS gateways to outside networks. The BASE I offline functions include BASE I reporting and the generation of Visa Card Recovery Bulletins. BASE I reporting includes authorization reports, exception □le and advice □le reports, and POS reports.

The Single Message System (SMS) component of the V.I.P. System processes full financial transactions. Full financial transactions contain both authorization and clearing information. Because the authorization and clearing information is contained in one message, this form of processing is referred to as single-message processing. SMS also supports dual-message processing of authorization and clearing messages, communicating with BASE I and accessing outside networks, as required, to complete transaction processing.

SMS supports online functions, offline functions, and the SMS □les. The SMS □les comprise internal system tables that control system access and processing, and the SMS Cardholder Database, which contains □les of cardholder data used for PIN verification and for stand-in processing (STIP) authorization. The SMS online functions perform real-time cardholder transaction processing and exception processing. This processing supports both authorizations and full financial transactions. In addition, SMS supports the delivery of transactions to the BASE II System for members that use dual-message processing. SMS also accumulates reconciliation totals, performs activity reporting, and passes activity data to VisaNet, which supports settlement and funds transfer processing for SMS. VisaNet handles settlement and funds transfer as an automatic follow-up to SMS transaction processing. The SMS offline systems process settlement and funds transfer requests and provide settlement and activity reporting. They also support an offline bridge to and from BASE II for those Visa and Plus clearing transactions that are sent between an SMS member and a BASE II member.

The BASE II System is an international electronic batch transaction clearing system for the exchange of interchange data between acquirers and issuers. The system calculates interchange fees between members. BASE II performs the second part of dual-message processing. Through a BASE I System connection, members submit authorization messages, which are cleared through a VisaNet connection to BASE II. A bridge to the V.I.P. System permits interchange between BASE II processing centers and SMS processing centers.

The VisaNet Settlement Service (VSS) consolidates the settlement functions of SMS and of BASE II, including Interlink, into a single service for all products and services. Members and processors receive settlement information from SMS and from BASE II in a standardized set of reports. VSS provides flexibility in defining financial relationships, in selecting reports and report destinations, and in establishing funds transfer points. VisaNet processes interchange transactions for SMS and for BASE II through separate systems.

As noted, information passes between members and V.I.P. in the form of messages. For use with VisaNet, BASE I and SMS messages may be variations of the International Organization for Standardization (ISO) 8583 message, the international standard for the format of financial messages. Each message contains bit maps that specify the data fields that appear in the message, a message type identifier, and those fields that are needed for the specific function intended. The message header contains basic message identifiers and routing information, along with message processing control codes and flags. The message type identifier specifies the message class and the category of function. For instance, 0100 indicates an authorization request. A bit map specifies which data fields are in a message. In addition to a primary bit map, messages can include second and third bit maps. Each map contains 64-bit fields, corresponding to the number of possible fields in a message. The data fields contain the information needed to process a message.

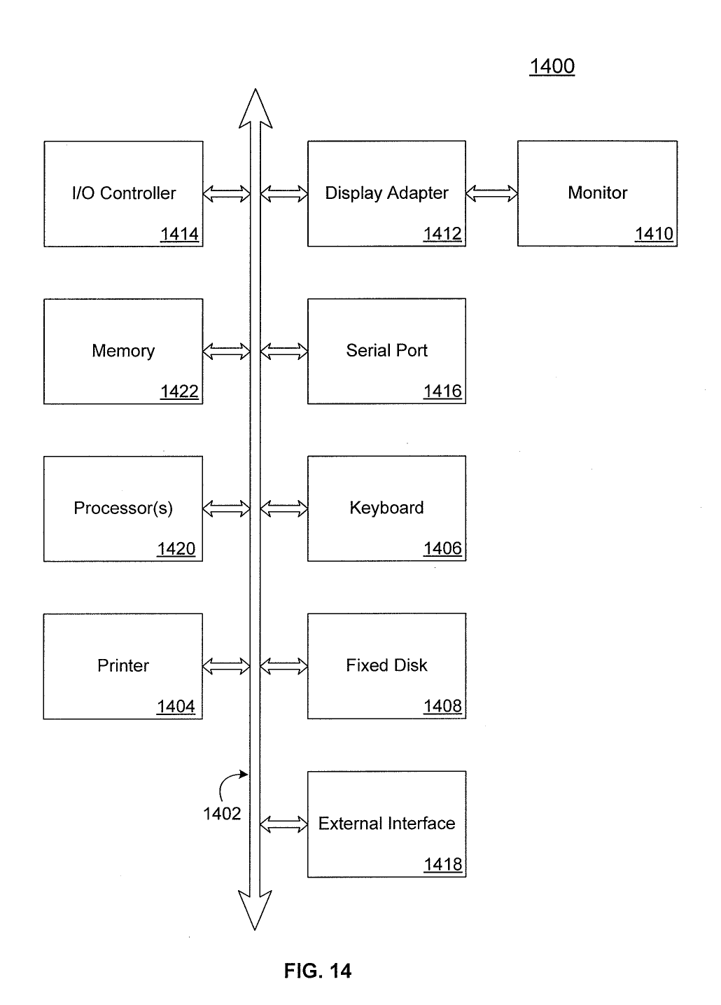

In accordance with at least some embodiments, the system, apparatus, methods, processes and/or operations used in implementing an embodiment of the invention may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system (e.g., a Merchant's POS terminal or data processing system, an Agency or Agency processor, etc.). As an example, FIG. 14 is a diagram illustrating elements that may be present in a computer device and/or system 1400 configured to implement a method and/or process in accordance with some embodiments of the present invention. The subsystems shown in FIG. 14 are interconnected via a system bus 1402. The subsystems may include one or more of a printer 1404, a keyboard 1406, a fixed disk 1408, or a monitor 1410, which is coupled to a display adapter 1412. Peripherals and input/output (I/O) devices, which couple to an I/O controller 1414, can be connected to the computer system by any number of means known in the art, such as a serial port 1416. For example, the serial port 1416 or an external interface 1418 can be utilized to connect the computer device 1400 to further devices and/or systems not shown in FIG. 14, including a wide area network such as the Internet, a mouse input device, and/or a scanner. The interconnection via the system bus 1402 allows one or more processors 1420 to communicate with each subsystem and to control the execution of instructions that may be stored in a system memory 1422 and/or the fixed disk 1408, as well as the exchange of information between subsystems. The system memory 1422 and/or the fixed disk 1408 may embody a tangible computer-readable medium.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

As used herein, the use of “a”, “an” or “the” is intended to mean “at least one”, unless specifically indicated to the contrary.

What is claimed is:

1. A method comprising:
accessing payment transaction data of a user, the payment transaction data being related to a plurality of payment transactions made using one or more payment accounts of the user;
parsing the payment transaction data to identify one or more online purchase transactions from among the plurality of payment transactions;
extracting a subset of data from the one or more online purchase transactions;
using the subset of data to create a summary of the one or more online purchase transactions; and
transmitting, via a communication network, the summary to a communication device of the user.

2. The method of claim 1, wherein the payment transaction data includes a merchant identifier for some or all of the plurality of payment transactions.

3. The method of claim 2, wherein parsing the payment transaction data to identify one or more online purchase transactions from among the plurality of payment transactions, comprises:
parsing the payment transaction data to obtain merchant identifiers for some or all of the plurality of payment transactions;
comparing the obtained merchant identifiers to a list of merchant identifiers for known online merchants; and
when one of the merchant identifiers obtained from the plurality of transaction data matches one of the merchant identifiers on the list, identifying the payment transaction as an online purchase transaction.

4. The method of claim 2, wherein the payment transaction data further includes a purchase amount, a purchase date, and at least one of a confirmation number, a shipment status, a shipment tracking number, and an item description for some or all of the plurality of payment transactions.

5. The method of claim 4, wherein the summary, for each of the online purchase transactions, includes the purchase amount, the purchase date, the merchant identifier, and at least one of the item description, the confirmation number, the shipment status, and the shipment tracking number.

6. The method of claim 1, wherein the summary of the one or more online purchases is created according to a request submitted by the user, the request including filter criteria for identifying the one or more online purchases to be included in the summary.

7. The method of claim 6, wherein the filter criteria include at least one of a purchase date range, a purchase amount range, one or more merchant identifiers, a shipping status, and a payment account used.

8. The method of claim 1, wherein the summary of the one or more online purchase transactions is created by an electronic wallet server.

9. A method comprising:
responsive to a request to provide a user with one or more promotional offers that may be of interest to the user,
accessing payment transaction data of a user, the payment transaction data comprising a plurality of payment transactions, wherein an item description is provided for each of the payment transactions, the item description describes an item the user purchased via the payment transaction;
accessing promotional offer data, the promotional offer data comprising a plurality of promotional offers, wherein an item description is provided for each of the promotional offers, the item description describes an item that corresponds to the promotional offer;
cross-referencing the item descriptions for the payment transactions with the item descriptions of the promotional offers to identify one or more promotional offers that correspond to one or more items purchased by the user; and
providing to the user the promotional offers that correspond to the one or more items purchased by the user.

10. The method of claim 9, wherein the request provided by the user includes filter criteria for identifying the one or more promotional offers that may be of interest to the user.

11. The method of claim 10, wherein the filter criteria include at least one of a purchase amount range, one or more item category descriptions, and one or more merchant identifiers.

12. The method of claim 9, wherein the promotional offers are identified and provided to the user by an electronic wallet server.

13. One or more computer-readable media collectively having thereon computer-executable instructions that, when executed by one or more computers cause the one or more computers to collectively, at least;
access payment transaction data of a user, the payment transaction data being associated with one or more payment accounts of the user and including a purchase amount, a purchase date, a confirmation number, a shipment status, a shipment tracking number, an item description and a merchant identifier;
parse the payment transaction data to identify a subset of the payment transaction data that is relevant to one or more online purchases made using the one or more payment accounts wherein at least one of the online purchases was made using an electronic wallet;
use the subset of the payment transaction data to create a summary of the one or more online purchases, the summary including the purchase amount, the purchase date, confirmation number, the shipment status, the shipment tracking number and the merchant identifier for the one or more online purchases; and
transmit, via a communication network, the summary of the one or more online purchases to a communication device of the user.

14. The one or more computer-readable media of claim 13, wherein the summary of the one or more online purchases is created according to a request submitted by the user, the request including filter criteria for identifying the one or more online purchases to be included in the summary.

15. The one or more computer-readable media of claim 13, wherein the summary of the one or more online purchases is displayed to the user via the communication device.

16. The one or more computer-readable media of claim 13, wherein the summary of the one or more online purchases is created by an electronic wallet server.
